(19) United States
(12) Patent Application Publication
(10) Pub. No.: US 2020/0182703 A1
(43) Pub. Date: Jun. 11, 2020

(54) Methods, Devices, and Systems for Monitoring Temperatures

(71) Applicant: Gina Marie Bourret, Belton, MO (US)

(72) Inventor: Gina Marie Bourret, Belton, MO (US)

(21) Appl. No.: 16/216,467

(22) Filed: Dec. 11, 2018

(51) Int. Cl. G01K 1/02; G01K 7/36; G01K 1/14

(52) U.S. Cl. CPC G01K 1/024; G01K 2207/06; G01K 1/14; G01K 7/36

(57) ABSTRACT

The present invention relates to systems, devices, and methods for measuring the internal temperatures of foods, particularly of foods in heated cooking environments such as ovens or rotisseries. The invention also encompasses systems, devices, and methods for measuring the internal temperatures of foods that are being held in warmers, coolers, buffet tables, and other food-holding environments. Devices of the invention can be used in cooking devices in which food is rotated without having portions of devices of the invention become entangled with either the cooking devices or food.

### BACKGROUND OF THE INVENTION

### A. Field of the Invention

The present invention relates to systems, devices, and methods for measuring temperatures in foods, in particular foods in high heat cooking environments.

### B. Description of the Related Art

Numerous methods and devices are known for measuring temperature. Many of which do not operate or have limited effectiveness above certain temperatures. This problem is particularly relevant in the food industry where the internal temperatures of foods need to be measured to ascertain the completion of cooking or to be monitored (e.g. buffet table, salad bar, etc.).

Most devices that are designed for monitoring the temperature of food include a cable connection that prevents the devices from effectively working in rotisserie ovens or smokers in which food is turned because the attached cables become tangled and stop operating. In general, the cables that are attached to such devices are long, difficult to clean to food-grade standards, sensitive to water damage, and difficult to store.

In smokers, such cables usually enter through a heavy lid and tend to be easily damaged around the entry area. When multiple temperature devices are used simultaneously, a user may lose track of which device is in a specific food because tangled cables make it difficult to determine which device is in a specific food.

Further, restaurants need a way of documenting time and temperature logs for food safety inspectors for rotisserie ovens and smokers, as well as, other heating and cooling environments. Currently, there is no easy way to do such monitoring without using wireless probes. Opening a lid, using an instant read thermometer, and manually logging samples at different times seems to be the only consistent way for restaurants and other purveyors of food to document time and temperature for food.

At present no devices are available that can alert users remotely that the internal temperature of food rotating on a rotisserie or in a smoker has reached a specified minimum or maximum temperature. Instead, users must open the oven or smoker to measure the temperature of the food that is being cooked. Wired solutions to this problem have limited capabilities. Besides the aforementioned difficulties, wired solutions only have a limited number of cables or ports so that these solutions have limited capacities.

Effective wireless solutions have been technically difficult to achieve and have limited capabilities because such devices require batteries that cannot function at high temperatures. In addition, wireless communication from within ovens, smokers, or other cooking devices is generally limited due to the metal construction of such cooking devices.

### SUMMARY OF THE INVENTION

The invention provides systems, methods, and devices for monitoring the internal temperature of food in a cooking chamber, such as an oven, smoker, or other enclosed cooking space. Advantageously, systems, methods, and devices of the invention are suitable for use in cooking chambers at high temperatures. The invention provides systems, methods, and devices that can be used to monitor the internal temperatures of multiple foods that are in a high temperature environment or a low temperature environment at the same time. In addition, the systems, methods, and devices of the invention can be used to monitor the internal temperatures of multiple foods that are in more than one high temperature environment, low temperature environment, or a combination thereof at the same time.

For example, systems, methods, and devices of the invention can monitor the internal temperatures of multiple, different cuts of meat or other food while cooking in a high temperature environment such as an oven, rotisserie, or smoker. Alternatively, systems, methods, and devices of the invention can monitor the internal temperatures of foods in both high and low temperature environments such as buffet lines, tables, warmers, or coolers. Advantageously, the invention provides that multiple environments having different temperatures can be monitored simultaneously. Further, the invention provides systems, devices, and methods that allow for the simultaneous monitoring of foods that have different desirable or targeted internal temperatures. For example, the invention provides systems and methods that monitor the internal temperature of ice cream in a cooler while at the same time measuring the internal temperature of a roast cooking in a high temperature chamber.

In one embodiment, systems of the invention comprise one or more wireless probes; a specialized UHF antenna; and a transceiver (reader) that receives a radio frequency identification (RFID) signal from the specialized UHF antenna. The transceiver can send data from such signals to be stored remotely.

In further embodiments, systems of the invention further comprise one or more wired probes wherein the wired probes are suitable for use in high temperature environments.

Systems of the invention can further include software to collect data for logging and food safety records and have the ability to sent alerts to multiple devices, such as cell phones, watches, computers, and the like, to indicate that a programmed temperature, e.g. a preferred maximum or minimum temperature, has been reached inside a food.

The present invention includes one or more wireless probes that are powered by a smart passive temperature sensor that transmits a radio frequency identification (RFID) signal. Those of skill in the art will appreciate that RFID signals are coupled in the radio frequency portion of the electromagnetic spectrum to uniquely identify an object. Thus, wireless probes of the invention may be tuned to transmit different RFID signals. Wireless probes of the invention do not include fuel cells (batteries). Smart passive sensors are known in the art.

Those of skill in the art will understand that electrical components, such as a printed circuit board (PCB), of the wireless probes of the invention are protected from the high heat of a cooking environment because these electrical components are located in the portion of the wireless probe that is inserted into the food. This portion of a wireless probe and its internal electrical components are exposed to the internal temperature of food rather than the high temperatures of the cooking chamber. Skilled artisans will recognize that a variety of PCBs configurations exist and that a different PCB or other electrical component will be preferred in different probe configurations. For example, the PCB or other electrical components that are preferred for larger probes may be less desirable in smaller probes and visa-versa.

The present invention also includes a transceiver (reader) that receives a signal from one or multiple probes via a specialized UHF antenna. Each signal indicates a temperature, specifically an internal temperature of the food into which a probe is inserted, that has been measured by a probe.

Specialized UHF antennae of the invention are constructed to withstand the high temperature environment of a cooking chamber. For example, a specialized UHF antenna of the invention can function at temperatures greater than 170° F., 180° F., 200° F., 220° F., 250° F., 275° F., 300° F., 325° F., 350° F., 375° F., 400° F., 425° F., 450° F., 475° F., or more. Suitable construction materials, such as various metals and alloys, are known in the art.

In some embodiments of the invention, systems include multiple specialized UHF antennae. For example, one specialized UHF antenna may be in a high temperature environment such as an oven or smoker and receive signals from probes located within the hot environment, and another specialized UHF antenna may external to the oven and receive signals from probes that are located in environments that are cooler, such as buffet lines, warmers, or coolers.

Advantageously, unlike systems that use wired probes, the number of wireless probes and specialized UHF antennae used in the invention are not limited by the availability of ports, cables, etc. Thus, systems, methods, and devices of the invention can include multiple wireless probes, as well as, multiple specialized UHF antennae.

Preferred embodiments include a transceiver that can connect to a server or form an internet connection to transmit data. More preferably, data are transmitted to cloud-based, remote software or storage using a WiFi (IEEE 802.11x.) or cellular signal. Preferred transceivers include a touchscreen that can be used to setup a system and to display temperatures or other information. An exemplary, preferred transceiver is a TAPPECUE (Innovating Solutions LLC, Belton, Mo., USA).

Embodiments of the invention may further include one or more wired probes. A wired probe may be used advantageously in high temperature chambers that are likely to expose a wireless probe to temperatures that exceed the upper limit for operation of the wireless probe. Those of skill in the art will appreciate that the upper temperature limit for operation will vary for different wireless probes. For example, wireless probes that have greater shielding of electronic components can operate at higher temperatures than probes with less shielding. Preferred wired probes can operate in high temperature chambers at temperatures that exceed 325° F., 340° F., 350° F., 375° F., 400° F., 425° F., 450° F., or more.

Greater shielding may be achieved through a variety of techniques that will be familiar to a skilled artisan. For example, greater shielding may be achieved by thicker material, more heat resistant material, or a combination thereof. Exemplary preferred materials are amorphous, high performance polymers with exceptional flame and heat resistance such as polyetherimides. A variety of thermoplastic polymers with different amounts of glass fiber (generally 10-40% glass fiber) are known in the art. Such thermoplastic polymers can deflect temperatures greater than 400° F.

Systems of the invention measure a food's internal temperature and comprise a wireless probe having a cover, an antenna printed circuit board (PCB), a probe tube, two antennae traces, two PCB traces, and an integrated circuit (IC) chip; an antenna assembly having a specialized ultra high frequency (UHF) antenna, a securing means, a PCB cable connection, an antenna connection cable, an antenna coax cable connection, and one or more fasteners; and a transceiver, wherein the wireless probe measures the internal temperature of the food and transmits a signal that indicates the internal temperature to the antenna assembly, the antenna assembly sends the received signal to the transceiver, and the transceiver communicates the internal temperature of the food.

Systems of the invention further comprise more than one wireless probe, wherein each wireless probe measures the internal temperature of a different food. Some systems of the invention also comprise a wired probe, wherein the wired probe measures the internal temperature of a food not having a wireless probe inserted into it. In some embodiments, systems of the invention include more than one wired probe.

Systems of the invention include an antenna assembly that is attached to a food container such that the UHF antenna in the antenna assembly is located on the interior of a food container and the PCB cable connection, antenna connection cable, antenna coax cable connection are located on the exterior of the food container. In preferred embodiments, the food container is a high temperature cooking chamber such as an oven, rotisserie, or smoker.

In some embodiments, systems of the invention include more than one antenna assembly.

Devices of the invention that measure a food's internal temperature comprise a wireless probe having a cover, an antenna printed circuit board (PCB), a probe tube, two antennae traces, two PCB traces, and an integrated circuit (IC) chip; an antenna assembly having a specialized ultra high frequency (UHF) antenna, a securing means, a PCB cable connection, an antenna connection cable, an antenna coax cable connection, and one or more fasteners; and a transceiver, wherein the wireless probe transmits a signal that indicates the internal temperature to the antenna assembly, and the antenna assembly sends the received signal to the transceiver, and the transceiver displays the internal temperature of the food.

In some embodiments, devices of the invention comprise more than one wireless probe.

In some embodiments, devices of the invention comprise at least one wired probe.

Methods of the invention that measure a food's internal temperature comprise inserting a first wireless probe into the food, wherein the first wireless probe transmits a signal that indicates the food's internal temperature; attaching an antenna assembly to the food's container, wherein the antenna assembly includes a specialized ultra high frequency (UHF) antenna that is attached to the interior of the food's container and the UHF antenna receives the signal transmitted from the first wireless probe; and attaching a transceiver to the antenna assembly, wherein the transceiver is external to the food's container, and the transceiver receives the signal from the UHF antenna, wherein the transceiver includes a display screen for viewing the temperature readings transmitted by the wireless probe.

In some embodiments, methods of the invention further comprise inserting a different (second) wireless probe into a different food, wherein the second wireless probe transmits a signal that indicates the different food's internal temperature to the antenna assembly.

In some embodiments, methods of the invention further comprise inserting a wired probe into a separate (third) food, wherein the wired probe transmits a signal that indicates the third food's internal temperature to the antenna assembly.

The invention also includes methods of fabricating devices to measure a food's internal temperature that comprise making a wireless probe having a cover, an antenna printed circuit board (PCB), a probe tube, two antennae traces, two PCB traces, and an integrated circuit (IC) chip, wherein the wireless probe can measure temperature; making an antenna assembly having a specialized ultra high frequency (UHF) antenna, a securing means, a PCB cable connection, an antenna connection cable, an antenna coax cable connection, and one or more fasteners; and attaching a transceiver to the antenna assembly.

Methods of fabricating devices of the invention further comprise making more than one wireless probe to include in such devices.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description. Further, while specific advantages of the invention are detailed herein, various embodiments may include some, none, or all of these enumerated advantages.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description presented herein. Unless specifically noted, articles depicted in the drawings are not necessarily drawn to scale.

FIG. 1 is an exploded view of a wireless probe.

FIG. 2. FIG. 2A is a front perspective view of an assembled probe. FIG. 2B is a rear view of an assembled probe (front and back are identical). FIG. 2C is a side view of an assembled probe (each side is identical). FIG. 2D is a top view of an assembled probe.

FIG. 3 is an exploded view of an antenna assembly.

FIG. 4. FIG. 4A shows an interior surface (dotted/dashed line) of a high temperature chamber with an antenna assembly mounted onto it and the relative position of a transceiver that is mounted on the exterior surface of the chamber. The back of the transceiver is shown. FIG. 4B shows the exterior surface of a chamber (dotted/dashed line) with the relative position of a transceiver that is mounted onto the surface. The front of the transceiver is shown.

FIG. 4C is a view from above of an antenna assembly that is mounted onto a surface (dotted/dashed line).

FIG. 5 is a perspective view of a fully assembled antenna assembly from the perspective of an interior surface (dotted/dashed line) and the relative position of a transceiver unit to it.

FIG. 6 is a perspective view of a transceiver unit relative to an external surface (dotted/dashed line) to which an antenna assembly is attached.

FIG. 7 illustrates a wireless temperature monitoring system for multiple foods.

### DETAILED DESCRIPTION

The invention provides systems for monitoring the temperature of food, specifically the internal temperature of the food, in a cooking chamber, such as an oven, smoker, or other enclosed cooking space. The invention also provides systems for monitoring the temperature of food that is being maintained at specific temperature(s) such as in a buffet table, salad bar, warmer, or cooler.

The system comprises a wireless probe; an antenna assembly that receives a radio frequency identification (RFID) signal from the wireless probe; and a transceiver that collects data from the antenna assembly and can display the data. Preferred transceivers are programmable, are able to connect to an internet, and transmit data to remote storage.

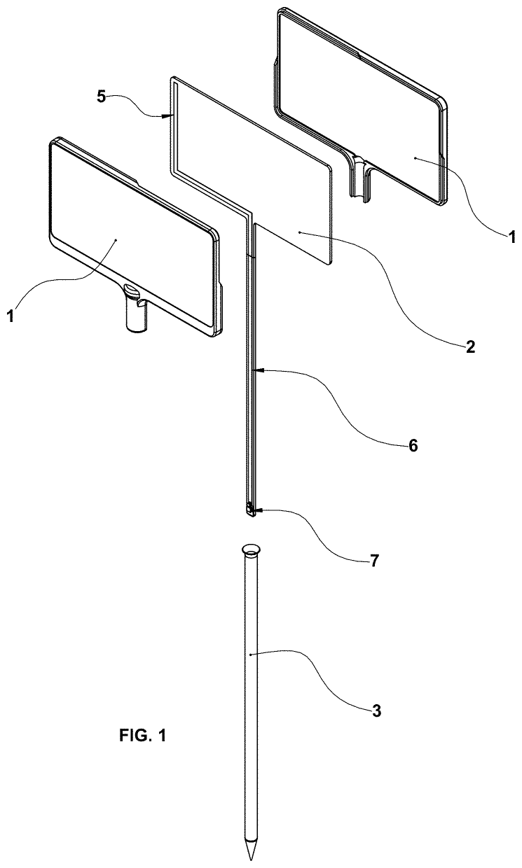

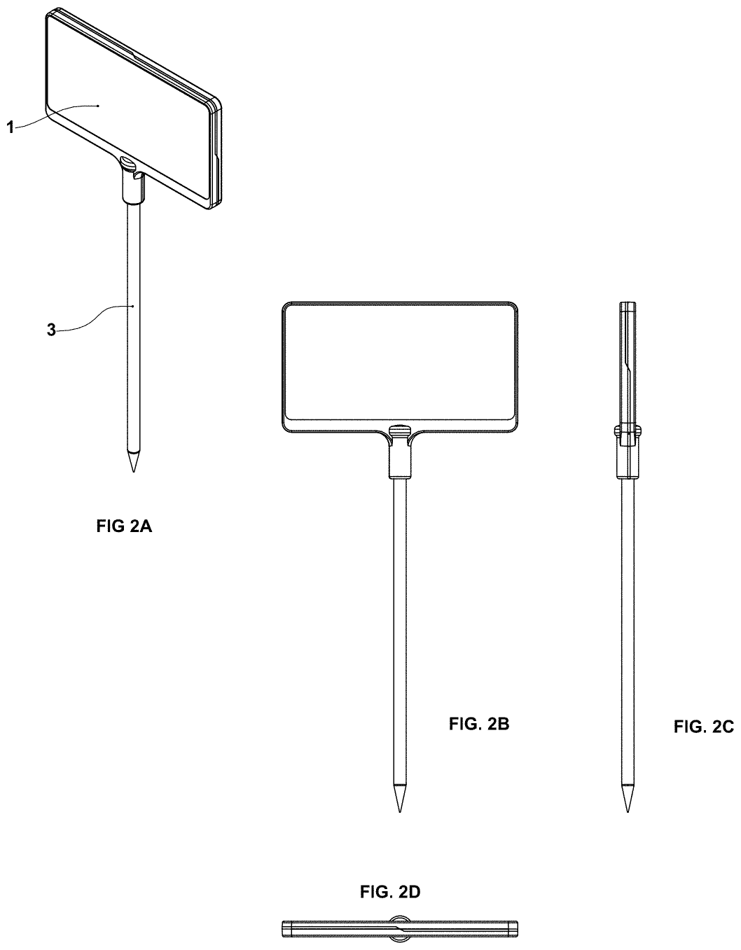

Exemplary wireless probes of the invention of shown in FIGS. 1 and 2. A wireless probe comprises two probe cover panels (1), an antenna printed circuit board (PCB) (2), a probe tube (3), two antennae traces (5), two PCB traces (6), and an integrated circuit (IC) chip (7).

Each probe cover panel (1) is a mirror image of each other. Each is composed of a high temperature resistant material. Preferred materials are thermoplastic polymers such as a polyetherimide. Such thermoplastic polymers are glass fiber reinforced and generally are composed of 10-40% glass fibers. An exemplary thermoplastic polymer is UItem 2300® (Emco Industrial Plastics Inc., Cedar Grove, N.J., USA). It is expected that any high performance, thermoplastic polymer can be used as long as it is resistant to the temperatures to which it would be exposed in a high temperature chamber (i.e. oven, rotisserie, smoker, etc.), is capable of preventing heat damage to the antenna PCB (2), and is suitable for use in and around foods. Preferably, such thermoplastic polymers are heat resistant to temperatures of at least 300 to 325° F., more preferably of at least 325 to 350° F., 350 to 375° F., 375 to 400° F., even more preferably of at least 400° F. or 400° F. to 425° F., and most preferably of over 425° F. Preferred thermoplastic polymers can be exposed continuously to temperatures of up to 340° F.

When assembled, the two probe cover panels (1) are sandwiched and sealed together using a high temperature resistant sealant. See FIGS. 2A, 2C and 2D. Those of skill in the art will recognize that a variety of high temperature resistant sealants exist, and any of these may be used as long as the sealants are suitable for use in and around foods after the sealants have set.

Within an assembled probe cover, and between the two probe cover panels (1), is an antenna PCB (2). An antenna PCB (2) has an upper portion with a front and a back, and a lower portion that extends from the upper portion and is inserted into a probe tube (3). Those of skill in the art will recognize that the upper and lower portions of an antenna PCB may be manufactured in two parts and then joined together during assembly of the invention. Alternatively, the upper and lower portions of an antenna PCB may be manufactured as a single unit.

The front of an antenna PCB (2) includes an antenna trace (5) that is a mirror image of the antenna trace (5) on the back of the antenna PCB (2). In FIG. 1, only one side (front) of the antenna PCB (2) is shown, as the other side (back) is identical. For example, if an antenna trace is on the left side of the front of an antenna PCB then the antenna trace on the back side of the antenna PCB is also on the left side (i.e. each antenna trace is on a different half of an antenna PCB rather than on the same half of the antenna PCB).

Antenna traces can be composed of any materials that are used to make a UHF antenna. Such materials are well understood in the art. Preferred materials can be bent to desired shapes with relative ease during installation.

Attached to the lower portion of the antenna PCB (2) are PCB traces (6) that extend, respectively, from each antenna trace (5) (i.e. one PCB trace extends from each respective antenna trace). The PCB traces (6) connect to one or more PCB electrical components (7) that comprise at least an integrated computer (IC) chip capable of transmitting a signal. PCB electrical components (7) are attached to the antenna PCB (2) near the terminus of the lower extended portion of the antenna PCB (2). See FIG. 1. Those of skill in the art will appreciate that a variety of suitable IC chips are available and will understand that the choice of IC chip depends at least in part upon the intended use of the invention and the environment in which it will be used. For example, the expected distance over which a signal from an IC chip must be transmitted, as well as any materials through which the signal must travel, will influence the choice of IC chip.

The probe tube (3) into which the lower extended portion of probe cover panel (1) is inserted can be composed of a variety of relatively rigid, food safe materials. A preferred material is stainless steel. Preferably, the top of the probe tube (3) is relatively flared outward to ease the insertion of the lower portion of the antenna PCB (2) into the tube.

While optional, such flaring can be used to assist in sealing the antenna PCB (2) to the probe tube (3) so that the antenna trace (5) and antenna PCB (2) are not exposed to high temperatures during operation. Additionally, the probe cover panel (1) includes a relatively short extension. When the probe cover is assembled, the extension from the probe cover encloses the top (e.g. the flared portion) of the probe tube (3) such that the antenna PCB is not exposed to high temperatures during operation. See FIG. 2A-2C. Those of skill in the art will recognize that alternative means of sealing can be used as long as such means are suitable for use in and around food and achieve the desired level of sealing and protection of internal components from high temperatures. During operation, the PCB and electrical components within the probe tube (3) are insulated from high temperatures by the food into which the probe is inserted, because the

PCB electrical components and portions of the antenna PCB within the associated probe tube are only exposed to the internal temperature of the food during use. During normal operations, the internal temperatures of foods will be considerably lower than the temperature of the chamber in which the food is cooking.

Those of skill in the art will recognize that while the exemplary wireless probes shown in FIGS. 1 and 2 have a particular external shape, this overall external shape can be varied without altering the functionality of a wireless probe. Thus, it will be understood that an assembled probe cover may have an overall rectangular, square, oval, round, or irregular shape as long as the functionality of the wireless probe is not prevented or inhibited. Similarly, the shape of a probe tube can vary. For example, a probe tube may be straight or bent as long as the shape of the tube does not inhibit or prevent the function of the wireless probe or prevent a user from inserting the tube into the food to be monitored. Those of skill in the art will be aware that wired probes having bent shapes are currently available and such shapes are expected to be suitable for wireless probes.

Preferred PCB electrical components for use in the invention are powered by a smart, passive, temperature sensor. Such sensors are known in the art, can transmit RFID signals, and do not require a battery. Those of skill in the art will understand that such sensors can be tuned to desired frequencies.

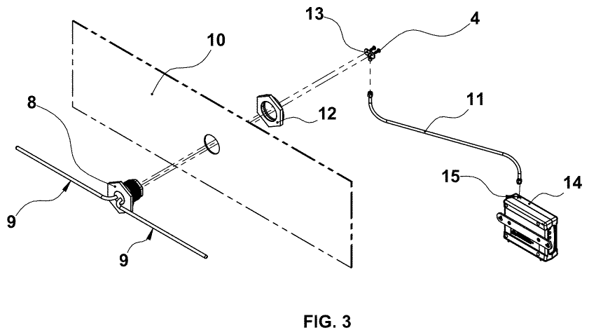

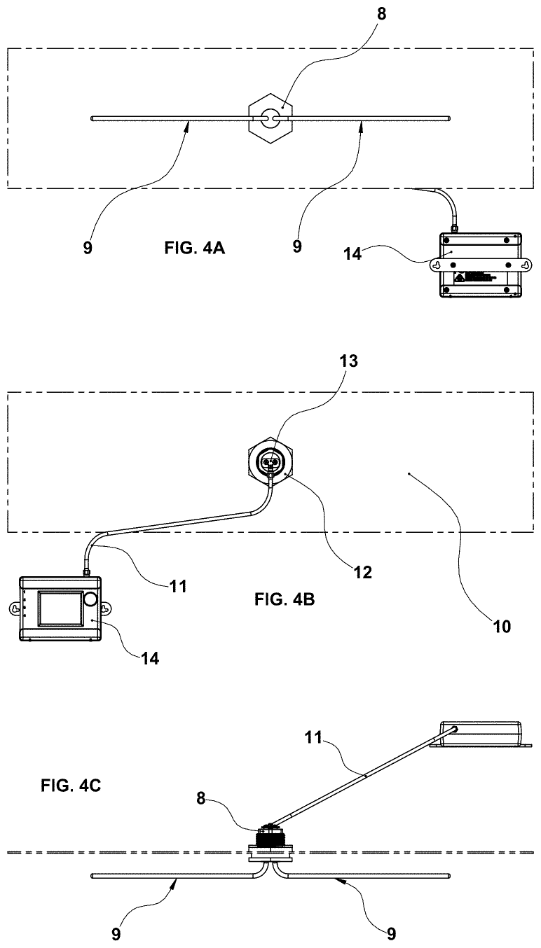

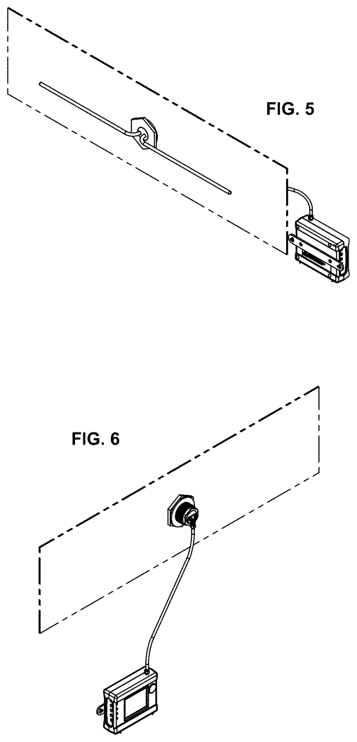

Wireless probes of the invention transmit an RFID signal that can be received by a specialized ultra high frequency (UHF) antenna. An exemplary specialized UHF antenna configuration is depicted in FIGS. 3-5. Skilled artisans will be familiar with UHF antennae and recognize that UHF antennae can have a variety of configurations to function as desired. Different configurations may be desired to improve signal reception, and users will understand that such adjustments are known in the art.

In the exemplary configuration shown in the figures, antenna (9) is in a “rabbit ear” configuration. Those of skill in the art will be aware that common configurations for UHF antennae also include a bowtie, ring, or loop among others. It is expected that any of these common configurations could be used in the invention as long as the antenna is capable of receiving signals from the wireless probe.

A specialized UHF antenna of the invention attaches to and through the wall of a high temperature chamber (i.e. oven, rotisserie, smoker, etc.). Specifically, antenna (9) is located on the interior of the high temperature chamber and is secured to the high temperature chamber on a wall (10) of the chamber by a suitable hub fitting (8) and hub nut (12). See FIGS. 3, 4A, and 5. The antenna (9) passes through the wall (10) and connects to a PCB cable connection (13) with one or more fasteners (4). Those of skill in the art will recognize that a variety of suitable hub fittings, hub nuts, and fasteners exist. Preferred fasteners are screws. Further, the antenna (9) can be secured to a wall, bulkhead, panel, or other suitable interior surface of the high temperature chamber. The choice of where to attach the antenna will, in part, be determined by the specific configuration and use(s) of the high temperature chamber. The PCB cable connection (13) connects to an antenna connection cable (11). Antenna connection cables are well known in the art. Preferred cables are coax cables having micro connectors.

The antenna connection cable (11), in turn, connects to a transceiver (14) by an antenna coax cable connection (15). See FIGS. 3, 4B, 4C, 5, and 6. Transceivers and coax cable connection are well known in the art. A preferred transceiver is a TAPPECUE (Innovating Solutions LLC, Belton, Missouri, USA). Desirable transceivers include a display screen for viewing temperature readings, logs, other data, and a means for users to program a system.

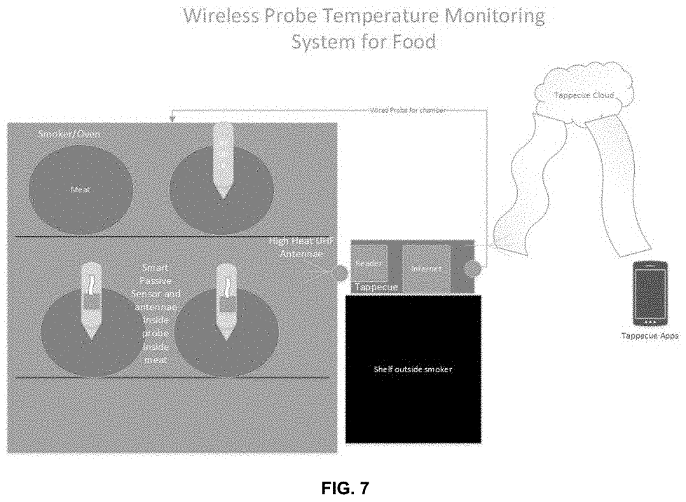

Systems of the invention can include more than one probe. See FIG. 7. For example, a wireless probe can be inserted into one piece of food (e.g. a leg of lamb) and another wireless probe can be inserted into a different piece of food (e.g. a turkey) that are cooking simultaneously in the same high temperature chamber. Each probe would send separate signals to indicate the internal temperature of the respective food into which the probe is inserted. A single specialized UHF antenna and transceiver may be used to receive signals and collect data from multiple probes at the same time. Advantageously, a user would be able to ascertain the internal temperatures of different foods that have different preferred final cooking temperatures. For example, a preferred internal cooking temperature for rare beef is 145° F., and the recommended internal cooking temperature for poultry is 170° F.

Similarly, a user may monitor the internal temperatures of multiple foods that are in multiple cooking chambers, warmers, coolers, or other containers through the use of systems of the invention that include multiple wireless probes. Those of skill in the art will recognize that the signals transmitted by the wireless probes will have limited ranges. Thus, in such systems, more than one specialized UHF antennae may be desirable or necessary. A single transceiver can receive and collect data from multiple antennae. In some instances, it may be preferred that multiple transceivers are used because of user preferences and objectives among other factors.

Further, systems of the invention can include one or more wired probes with one or more wireless probes. It is envisioned that wired probes would be preferred in very high temperature cooking chambers where the continuous cooking temperatures exceed the tolerances of the wireless probes or in instances where having a wire (cable) present will not interfere with the operation of the probe.

Preferably, transceivers of the invention can connect to the internet and transmit data to be stored remotely. The preferred transceiver, TAPPECUE, has such capabilities. Suitable transceivers include internet connectivity; can be connected to multiple wireless or wired probes; include a power or charging port; have a touch screen display for programming and viewing; and include a plastic enclosure that is water or moisture-resistant.

Unless defined otherwise, all technical and scientific terms used herein have the same meaning as is commonly understood by one of skill in the art to which this invention belongs at the time of filing. Terminology used herein is for the purpose of describing particular embodiments of the invention and is not intended to be limiting. The meaning and scope of terms should be clear; however, in the event of any latent ambiguity, definitions provided herein take precedent over any dictionary or extrinsic definition. Further, unless otherwise required by context, singular terms shall include pluralities and plural terms shall include the singular unless the content clearly dictates otherwise. Herein, the use of “or” means “and/or” unless stated otherwise. Furthermore, the use of the term “including”, as well as other forms such as “includes” and “included” is not limiting. As used herein, “each” refers to each member of a set or each member of a subset of a set. All patents and publications referred to herein are incorporated by reference herein.

Unless defined otherwise, all technical and scientific terms used herein have the same meaning as is commonly understood by one of skill in the art to which this invention belongs at the time of filing. Terminology used herein is for the purpose of describing particular embodiments of the invention and is not intended to be limiting. The meaning and scope of terms should be clear; however, in the event of any latent ambiguity, definitions provided herein take precedent over any dictionary or extrinsic definition. Further, unless otherwise required by context, singular terms shall include pluralities and plural terms shall include the singular unless the content clearly dictates otherwise. Herein, the use of “or” means “and/or” unless stated otherwise. As used herein, “each” refers to each member of a set or each member of a subset of a set. All patents and publications referred to herein are incorporated by reference herein.

It should be appreciated by those of skill in the art that the techniques, devices, and systems disclosed herein represent those techniques, devices, and systems discovered by the inventor to function well in the practice of the invention, and thus can be considered to constitute preferred modes of practice. However, those of skill in the art should, in light of the present disclosure, appreciate that many changes can be made in the specific embodiments which are disclosed and still obtain a like or similar result without departing from the spirit and scope of the invention. Thus, the present invention should not be limited to the exemplary techniques, devices, and systems illustrated herein.

1. A system for measuring a food's internal temperature comprising
a) a wireless probe having a cover, an antenna printed circuit board (PCB), a probe tube, two antennae traces, two PCB traces, and an integrated circuit (IC) chip;
b) an antenna assembly having a specialized ultra high frequency (UHF) antenna, a securing means, a PCB cable connection, an antenna connection cable, an antenna coax cable connection, and one or more fasteners; and
c) a transceiver wherein,
the wireless probe measures the internal temperature of the food and transmits a signal that indicates the internal temperature to the antenna assembly, the antenna assembly sends the received signal to the transceiver, and the transceiver communicates the internal temperature of the food.

2. The system of claim 1 further comprising more than one wireless probe, wherein each wireless probe measures the internal temperature of a different food.

3. The system of claim 1 further comprising a wired probe, wherein the wired probe measures the internal temperature of a food not having a wireless probe inserted into it.

4. The system of claim 3 further comprising more than one wired probe.

5. The system of claim 1, wherein the antenna assembly is attached to a food container such that the UHF antenna is located on the interior of the food container and the PCB cable connection, antenna connection cable, antenna coax cable connection are located on the exterior of the food container.

6. The system of claim 5, wherein the food container is a high temperature cooking chamber.

7. The system of claim 1 further comprising more than one antenna assembly.

8. A device to measure a food's internal temperature comprising
a) a wireless probe having a cover, an antenna printed circuit board (PCB), a probe tube, two antennae traces, two PCB traces, and an integrated circuit (IC) chip;
b) an antenna assembly having a specialized ultra high frequency (UHF) antenna, a securing means, a PCB cable connection, an antenna connection cable, an antenna coax cable connection, and one or more fasteners; and
c) a transceiver wherein,
the wireless probe transmits a signal that indicates the internal temperature to the antenna assembly, and the antenna assembly sends the received signal to the transceiver, and the transceiver displays the internal temperature of the food.

9. The device of claim 8 further comprising more than one wireless probe.

10. The device of claim 8 further comprising at least one wired probe.

11. A method of measuring a food's internal temperature comprising the steps of
a) inserting a first wireless probe into the food, wherein the first wireless probe transmits a signal that indicates the food's internal temperature;
b) attaching an antenna assembly to the food's container, wherein the antenna assembly includes a specialized ultra high frequency (UHF) antenna that is attached to the interior of the food's container and the UHF antenna receives the signal transmitted from the first wireless probe; and
c) attaching a transceiver to the antenna assembly, wherein the transceiver is external to the food's container, and the transceiver receives the signal from the UHF antenna,
wherein the transceiver includes a display screen for viewing the temperature readings transmitted by the wireless probe.

12. The method of claim 11 further comprising inserting a different (second) wireless probe into a different food, wherein the second wireless probe transmits a signal that indicates the different food's internal temperature to the antenna assembly.

13. The method of claim 11 further comprising inserting a wired probe into a separate (third) food, wherein the wired probe transmits a signal that indicates the third food's internal temperature to the antenna assembly.

14. (canceled)

15. The method of claim 13 further comprising making one or more wireless probes.

16. A method of fabricating a device to measure a food's internal temperature comprising
a) making a wireless probe having a cover, an antenna printed circuit board (PCB), a probe tube, two antennae traces, two PCB traces, and an integrated circuit (IC) chip, wherein the wireless probe can measure temperature;
b) making an antenna assembly having a specialized ultra high frequency (UHF) antenna, a securing means, a PCB cable connection, an antenna connection cable, an antenna coax cable connection, and one or more fasteners; and
c) attaching a transceiver to the antenna assembly.
